(19) United States
(12) Patent Application Publication
(10) Pub. No.: US 2018/0270424 A1
(43) Pub. Date: Sep. 20, 2018

(54) REPOSITIONING CAMERA LENSES DURING CAPTURING OF MEDIA

(71) Applicant: MOTOROLA MOBILITY LLC, Chicago, IL (US)

(72) Inventors: QIAOTIAN LI, WILMETTE, IL (US); VALERIY MARCHEVSKY, GLENVIEW, IL (US); SUSAN YANQING XU, WESTMONT, IL (US)

(21) Appl. No.: 15/464,118

(22) Filed: Mar. 20, 2017

(51) Int. Cl. H04N 5/232; G02B 27/64; H04N 5/225

(52) U.S. Cl. CPC H04N 5/23287; H04N 5/23229; H04N 5/2258; G02B 27/646

(57) ABSTRACT

A method, system, and computer program product for repositioning lenses of at least one camera of a plurality of cameras during capture of media. The method includes receiving, via at least one input device, a request to capture a media of a current scene. The method further includes capturing a primary media, via a primary camera sensor that includes an optical image stabilization (OIS) sensor, and simultaneously capturing at least one secondary media via at least one secondary camera sensor. The method further comprises, repositioning, during capture of the primary media and the at least one secondary media, at least one lens of at least one of the primary camera sensor and the at least one secondary camera sensor to compensate for a detected movement. The method further includes automatically fusing the primary media and the at least one secondary media to create a fused media.

### BACKGROUND

### 1. Technical Field

The present disclosure generally relates to electronic devices having camera sensors and in particular to a method for fusing media captured by multiple camera sensors to create a composite media.

### 2. Description of the Related Art

Modern image capturing devices, such as cameras associated with cellular phones, are equipped with cameras that can be used to capture images and/or video. These devices use one or more dedicated cameras within the device to focus on a scene and capture an image and/or video associated with the scene. However, movement during capture of the scene may cause the captured image/video to be blurry and/or unfocused.

### BRIEF DESCRIPTION OF THE DRAWINGS

The description of the illustrative embodiments is to be read in conjunction with the accompanying drawings. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an image capturing device within which certain aspects of the disclosure can be practiced, in accordance with one or more embodiments;

FIG. 2 illustrates an example image capturing device configured to fuse media captured using a plurality of camera sensors, in accordance with one or more embodiments;

FIG. 3 illustrates a first example image capturing device configured with a primary camera having an optical image stabilization (OIS) sensor, a secondary camera having an OIS sensor, and a transformation module for calculating a correction ratio for the primary and secondary camera sensors, in accordance with a first embodiment of the disclosure;

FIG. 4 illustrates a second example image capturing device configured with a primary camera having an OIS sensor, a secondary camera having an OIS sensor, and a transformation module for calculating a correction ratio for the secondary camera, in accordance with a second embodiment of the disclosure;

FIG. 5 illustrates a third example image capturing device configured with a primary camera having an OIS sensor, a secondary camera, and a transformation module for calculating a correction ratio for the secondary camera, in accordance with a third embodiment of the disclosure;

FIG. 6 illustrates a fourth example image capturing device configured with a primary camera having an OIS sensor, a secondary camera that is directly connected to the primary camera, and a transformation module for calculating a correction ratio for the secondary camera, in accordance with a fourth embodiment of the disclosure;

FIG. 7 is a flow chart illustrating a method for correcting for a detected movement of at least one camera of an image capturing device during capture of media and for fusing media captured by a plurality of camera sensors to create a fused media, in accordance with one or more embodiments;

FIG. 8 is a flow chart illustrating a method for determining a correction ratio to apply to a lens of a primary camera sensor and a lens of at least one secondary camera sensor based on a detected movement of the primary camera sensor and a detected movement of the at least one secondary camera sensor, in accordance with the first embodiment of the disclosure;

FIG. 9 is a flow chart illustrating a method for determining a correction ratio to apply to a lens of at least one secondary camera sensor based on a detected movement of the at least one secondary camera sensor, in accordance with the second embodiment of the disclosure;

FIG. 10 is a flow chart illustrating a method for determining a correction ratio to apply to a lens of at least one secondary camera sensor based on a detected movement of the at least one primary camera sensor, in accordance with the third embodiment of the disclosure; and

FIG. 11 is a flow chart illustrating a method for determining a correction ratio to apply to a lens of at least one secondary camera sensor based on a detected movement of the at least one primary camera sensor, in accordance with the fourth embodiment of the disclosure.

### DETAILED DESCRIPTION

The illustrative embodiments provide a method, a system, and a computer program product for repositioning lenses of at least one camera of a plurality of cameras during capture of media and creating a fused media from media captured by the plurality of camera sensors. The method includes receiving, via at least one input device, a request to capture a media of a current scene. The method further includes capturing a primary media, via a primary camera sensor that includes an optical image stabilization (OIS) sensor, and simultaneously capturing at least one secondary media via at least one secondary camera sensor. The method further comprises, during capture of the primary media and the at least one secondary media, repositioning at least one lens of at least one of the primary camera sensor and the at least one secondary camera sensor to compensate for a detected movement of at least one of the primary camera sensor and the at least one secondary camera sensor. The method further includes automatically fusing the primary media and the at least one secondary media to create a fused media. The method further includes providing the fused media to at least one output device.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

Those of ordinary skill in the art will appreciate that the hardware components and basic configuration depicted in the following figures may vary. For example, the illustrative components within image capturing device 100 are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

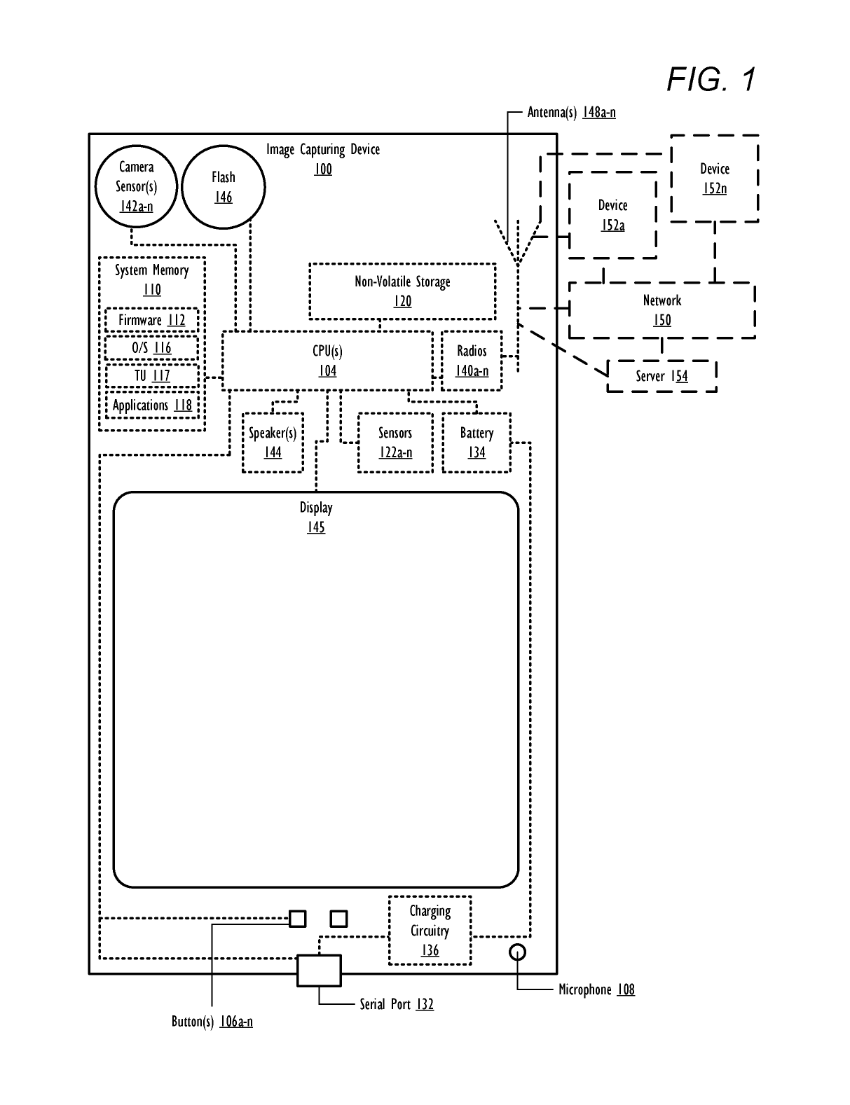

Now turning to FIG. 1, there is illustrated an example image capturing device 100 within which one or more of the described features of the various embodiments of the disclosure can be implemented. In one embodiment, image capturing device 100 can be any electronic device that is equipped with at least two camera sensors. Example image capturing devices can include, but are not limited to, a desktop computer, a monitor, a notebook computer, a mobile phone, a digital camera, a video recorder, or a tablet computer. Image capturing device 100 includes at least one processor or central processing unit (CPU) 104. CPU(s) 104 is coupled to non-volatile storage 120 and system memory 110, within which firmware 112, operating system (OS) 116, transformation utility (TU) 117, and applications 118 can be stored for execution by CPU(s) 104. According to one aspect, TU 117 executes within image capturing device 100 to perform the various methods and functions described herein. In one or more embodiments, TU 117 corrects for a detected movement of camera sensors 142a-n during capture of media and fuses the captured media to create a composite/fused media. For simplicity, TU 117 is illustrated and described as a stand-alone or separate software/firmware/logic component, which provides the specific functions and methods described below. However, in at least one embodiment, TU 117 may be a component of, may be combined with, or may be incorporated within firmware 112, or OS 116, and/or within one or more of applications 118.

As shown, image capturing device 100 may include input devices and output devices that enable a user to interface with image capturing device 100. In the illustrated embodiment, image capturing device 100 includes at least two camera sensors 142a-n, camera flash(es) 146, display 145, hardware buttons 106a-n, microphone(s) 108, and speaker(s) 144. While two camera sensors (camera sensors 142a-n) are illustrated, image capturing device 100 may include additional camera sensors, in other embodiments. Hardware buttons 106a-n are selectable buttons which are used to receive manual/tactile input from a user to control specific operations of image capturing device 100 and/or of applications executing thereon. In one embodiment, hardware buttons 106a-n may also include, or may be connected to, one or more sensors (e.g. a fingerprint scanner) and/or may be pressure sensitive. Hardware buttons 106a-n may also be directly associated with one or more functions of a graphical user interface (not pictured) and/or functions of an OS, application, or hardware of image capturing device 100. In one embodiment, hardware buttons 106a-n may include a keyboard. Microphone(s) 108 may be used to receive spoken input/commands from a user. Speaker(s) 144 is used to output audio.

CPU(s) 104 is also coupled to sensors 122a-n and display 145. Sensors 122a-n can include, but are not limited to, at least one of: infrared (IR) sensors, thermal sensors, light sensors, motion sensors and/or accelerometers, proximity sensors, and camera/image sensors. Display 145 is capable of displaying text, media content, and/or a graphical user interface (GUI) associated with or generated by firmware and/or one or more applications executing on image capturing device 100. The GUI can be rendered by CPU(s) 104 for viewing on display 145, in one embodiment, or can be rendered by a graphics processing unit (GPU), in another embodiment. In one embodiment, display 145 is a touch screen that is also capable of receiving touch/tactile input from a user of image capturing device 100, when the user is interfacing with a displayed GUI. In at least one embodiment, image capturing device 100 can include a plurality of virtual buttons or affordances that operate in addition to, or in lieu of, hardware buttons 106a-n. For example, image capturing device 100 can be equipped with a touch screen interface and provide, via a GUI, a virtual keyboard or other virtual icons for user interfacing therewith.

Image capturing device 100 also includes serial port 132 (e.g., a universal serial bus (USB) port), battery 134, and charging circuitry 136. Serial port 132 can operate as a charging port that receives power via an external charging device (not pictured) for charging battery 134 via charging circuitry 136. Battery 134 may include a single battery or multiple batteries for providing power to components of image capturing device 100. Serial port 132 may also function as one of an input port, an output port, and a combination input/output port. In one embodiment, battery 134 may include at least one battery that is removable and/or replaceable by an end user. In another embodiment, battery 134 may include at least one battery that is permanently secured within/to image capturing device 100.

Image capturing device 100 may also include one or more wireless radios 140a-n and can include one or more antenna(s) 148a-n that enable image capturing device 100 to wirelessly connect to, and transmit and receive voice and/or data communication to/from, one or more other devices, such as devices 152a-n and server 154. As a wireless device, image capturing device 100 can transmit data over a wireless network 150 (e.g., a Wi-Fi network, cellular network, Bluetooth® network (including Bluetooth® low energy (BLE) networks), a wireless ad hoc network (WANET), or personal area network(PAN)). In one embodiment, image capturing device 100 may be further equipped with infrared (IR) device (not pictured) for communicating with other devices using an IR connection. In another embodiment, wireless radios 140a-n may include a short-range wireless device, including, but not limited to, a near field communication (NFC) device. In still another embodiment, image capturing device 100 may communicate with one or more other device(s) using a wired or wireless USB connection.

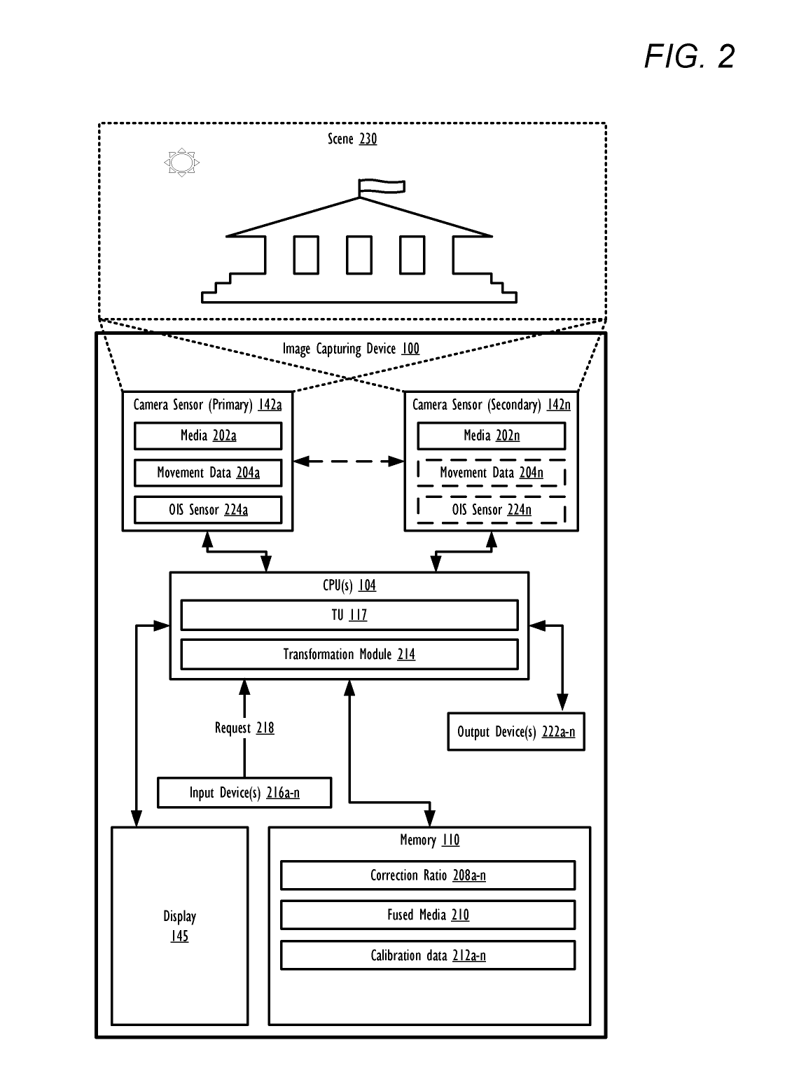

FIG. 2 is a block diagram illustrating additional functional components within example image capturing device 100, which is configured to fuse media captured using a plurality of camera sensors, in accordance with one or more embodiments of the present disclosure. As illustrated, image capturing device 100 includes CPU(s) 104, memory 110, camera sensors 142a-n, display 145, input device(s) 216a-n, and output devices 222a-n. In one or more embodiments, camera sensors 142a-n are used to capture media 202a-n, including images and/or video, in example scene 230. Media 202a-n may also include metadata of current scene 230 that is captured by camera sensors 142a-n. In one embodiment, CPU(s) 104 executes TU 117, which includes transformation module 214. Transformation module 214 calculates correction ratio(s) 208a-n based on calibration data 212a-n associated with camera sensors 142a-n and movement data 204a-n corresponding to a detected movement of camera sensors 142a-n. In another embodiment, transformation module 214 is a dedicated processing device separate from CPU(s) 104 that is configured to receive movement data 204a-n and calculate correction ratio(s) 208a-n. In still another embodiment, transformation module 214 is a dedicated processing device located within at least one camera sensor (e.g., camera sensor 142n) that is connected to, and receives movement data from, another camera sensor (e.g., camera sensor 142a). Transformation module 214 applies correction ratio(s) 208a-n to at least one of camera sensors 142a-n to correct for a movement of camera sensors 142a-n during the capture of media 202a-n. CPU(s) 104 fuses the captured media 202a-n to create a composite media (fused media 210). Fused media 210 is then provided to at least one output device (e.g., output device(s) 222a-n) and/or stored in memory 110.

In the various embodiments described herein, at least one of camera sensors 142a-nincludes an optical image stabilization (OIS) sensor 224a-n and is identified as a primary camera sensor (e.g., primary camera sensor 142a). In one embodiment, a particular camera sensor having an OIS sensor may be pre-identified as primary camera sensor 142a. In another embodiment, prior to capturing media 202a-n, CPU(s) 104 identifies a particular camera sensor having an OIS sensor 224a-n as primary camera sensor 142a. It should be noted that camera sensors 142a-n may include color camera sensors (e.g., Red Green Blue (RGB) and/or Bayer sensors), monochromatic camera sensors, or any combination thereof. For example, primary camera sensor 142a may be a monochromatic camera sensor and secondary camera sensor 142n may be a color camera sensor. In one embodiment, each of camera sensors 142a-n have a same pixel size (e.g., 13 megapixels). In another embodiment, camera sensors 142a-n have different pixel sizes. For example, primary camera sensor 142a has a pixel size of 13 megapixels and secondary camera sensor 142n has a pixel size of 8 megapixels. In one embodiment, each of camera sensors 142a-n has a same lens angle (e.g., 55 millimeters). In another embodiment, camera sensors 142a-n have different lens angles. For example, primary camera sensor 142a has a lens angle of 55 millimeters and secondary camera sensor 142n has lens angle of 24 millimeters. Additionally, while two camera sensors (primary camera 142a and secondary camera 142n) are illustrated in FIG. 2, in other embodiments image capturing device 100 may include multiple secondary camera sensors. In those other embodiments, media captured by each of the secondary camera sensors may be fused with the primary media 202a to create fused media.

OIS sensors 224a-n include one or more sensors (e.g., gyroscopes) that detect a movement of a corresponding camera sensor. OIS sensors 224a-n also include a plurality of actuators/motors that are used to manipulate a position of a lens of a corresponding camera sensor based on the detected movement. In one or more embodiments, OIS sensors 224a-n may directly manipulate an X, Y, and/or Z-axis position of a lens of a corresponding camera during capture of a media, based on a detected movement of the camera sensor. The manipulation of an X, Y, and/or Z-axis position of a lens is also referred to herein as self-correction. By manipulating a position of a lens based on a detected movement, OIS sensor 224a-n ensures the lens is properly aligned with an imaging sensor of the camera sensor so that light passing through the lens is properly projected and/or focused on the capture sensor. This ensures that a clear and focused media is captured by the camera sensor. In one or more embodiments, at least one of OIS sensors 224a-n does not self-correct based on a detected movement, but instead provides the detected movement to transformation module 214 as movement data 204a-n. Movement data 204a-n identifies a movement of a corresponding camera sensor in each of X, Y, and Z axes during recording of media. In response to transmitting movement data 204a-n to transformation module 214, OIS sensors 224a-n may subsequently receive, from transformation module 214, correction ratio 208, which identifies corrections to apply to a position of a lens of a corresponding camera in each of X, Y, and Z directions, as described in greater detail below.

CPU(s) 104a-n receives, from at least one of input devices 216a-n, request 218 to capture media 202a-n including images and/or video. Input devices 216a-n may include, but are not limited to, hardware buttons (e.g., buttons 106a-n) and/or microphones (e.g., microphone 108), and touch screen displays. For example, in response to detecting depression/selection of a shutter button (e.g., input device 216a) of image capturing device 100, request 218 may be generated and automatically transmitted to CPU(s) 104. In another embodiment, request 218 may be received from a software application executing on CPU(s) 104. In still another embodiment, request 218 may be received from another device (e.g., device 152a) that is communicatively coupled to image capturing device 100.

In response to receiving request 218, CPU(s) 104 automatically initializes a capture of media 202a-n by camera sensors 142a-n. During capture of media 202a-n by camera sensors 142a-n, transformation module 214 may receive movement data 204a-n from select camera sensors 142a-n that are equipped with an OIS sensor (e.g., OIS sensors 224a-n). Transformation module 214 calculates correction ratio(s) 208a-n for at least one of camera sensors 142a-n based on movement data 204a-n and calibration data 212a-n. Calibration data 212a-n specifies a distance between primary camera sensor 142a and secondary camera sensor(s) 142n. Calibration data 212a-n may further include geometry data that identifies, for a corresponding camera 142a-n, an angle, alignment, and/or sensor flex of a corresponding camera sensor 142a-n relative to a chassis of image capturing device 100 and/or a particular reference point (e.g., a center point or another camera) on image capturing device 100. In one embodiment, calibration data 212a-n for camera sensors 142a-n is stored in memory (e.g., memory 110) that is accessible to transformation module 214. In another embodiment, calibration data 212a-n of camera sensors 142a-n is stored within a read-only memory (e.g., an electrically erasable programmable read-only memory (EEPROM)) at each camera 142a-n that is accessible to transformation module 214. Correction ratios 208a-n identify corrections to apply to a position of a lens of a corresponding camera sensor 142a-n in each of X, Y, and Z directions to counteract for a detected movement of the corresponding camera sensor 142a-n during capture of media 202a-n. That is, correction ratios 208a-n, when applied to at least one camera sensor of a plurality of camera sensors, correct a pitch, roll, and yaw of a lens of the at least one camera sensor based on (1) a movement of at least one of the plurality of camera sensors and (2) and calibration data associated with the plurality of camera sensors.

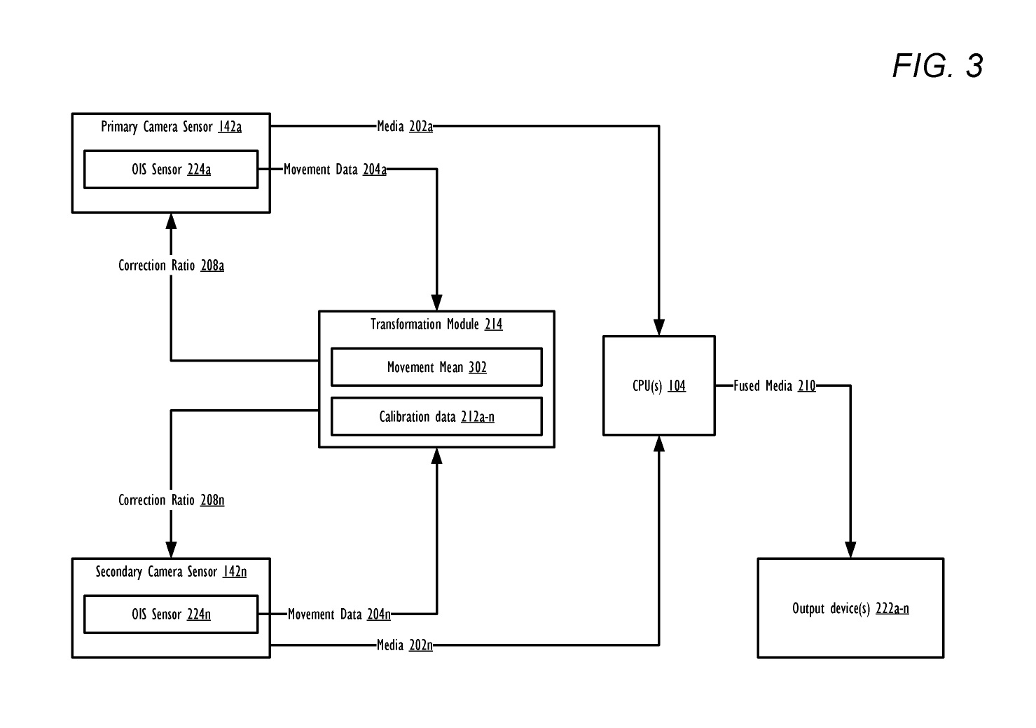

In one embodiment, in response to calculating correction ratio(s) 208a-n for at least one of camera sensors 142a-n, transformation module 214 directly applies correction ratio(s) 208a-n to the corresponding camera sensors 142a-n, as described in greater detail in FIGS. 3-6, below. By applying correction ratio (e.g., correction ratio 208a) to a camera sensor (e.g., camera sensor 142a), a lens of the camera sensor is able to be dynamically repositioned to counteract for a detected movement identified within movement data 204a-n. In response to camera 142a receiving correction ratio 208a, a lens of camera 142a is repositioned in accordance with that correction ratio 208a. In this manner, the at least one camera sensor is corrected to compensate for movement of the camera and/or the image capture device (e.g., hand shaking movement), during capture of media. Thus, correction ratios 208a-n provide a more timely and accurate correction of a position of a lens over a self-correction that is independently performed by an OIS sensor. In one or more of the embodiments described in FIGS. 3-6, below, at least one camera sensor that is not equipped with an OIS sensor is repositioned based on a calculated correction ratio.

In response to completion of the capture of media 202a-n, CPU(s) 104 receives media 202a-n from camera sensors 142a-n and performs a fusion of the received media 202a-n to create a fused media 210 that corrects for the movement of camera sensors 142a-n. In one or more embodiments, CPU(s) 104 removes and/or corrects common artifacts in media 202a-n and generates a single optimized composite media (fused media 210) by fusing the corrected media 202a-n. For example, CPU(s) 104 may correct white balance and/or shading, reduce or eliminate camera sensor noise, and/or remove bad pixels in media 202a-n prior to fusing media 202a-n. In one embodiment, CPU(s) 104 performs a pre-processing on media 202a-n prior to fusing media 202a-n to create fused media 210. For example, prior to fusing media 202a-n, CPU(s) 104 analyzes conditions in media 202a-n and optimizes detail, sharpness, brightness, and/or light conditions in media 202a-n. In one or more embodiments, CPU(s) 104 analyzes a difference in point-of-view between media 202a-n. In fusing media 202a-n, CPU(s) 104 utilizes geometry data (not illustrated) within calibration data 212a-n to locate and associate the same objects within media 202a-n. In response to identifying the same objects within media 202a-n, CPU(s) 104a-n aligns media 202a-n based on the identified the objects. CPU(s) 104 then combines/fuses media 202a-n to create fused media 210. It should be noted that when media 202a-n includes multiple frames (e.g., a burst image or video), the fusion of media 202a-n is performed for each corresponding frame captured by primary camera sensor 142a and secondary camera sensor 142n. Fused media 210 generated by CPU(s) 104 minimizes and/or eliminates adverse artifacts detected in media 202a-n and/or enhances image quality over the image quality of media 202a-n. In response to generating fused media 210, CPU(s) 104 provides fused media 210 to an output device (e.g., display 145), stores fused media 210 in a memory (e.g., memory 110), and/or provides fused media 210 to another device that is communicatively connected to image capturing device 100.

FIGS. 3-6, below, illustrate different embodiments in which transformation module 214 calculates and applies correction ratios 208a-n to at least one of camera sensors 142a-n to correct for a movement of at least one of camera sensors 142a-n during capture of media 202a-n. Thus, media 202a-n captured by at least one of camera sensors 142a-n is corrected for stabilization and dual-sensor calibration in a single operation. FIGS. 3-6 below are described with reference to the components of FIGS. 1-2. While the calculation of correction ratios 208a-n is described in the below embodiments as being performed by transformation module 214, in other embodiments the calculation of correction ratios 208a-n may be performed via a processor (e.g., CPU(s) 104) executing software code of TU 117 within an image capturing device (e.g., image capturing device 100).

Referring now to FIG. 3, there is illustrated a first example image capturing device 100 comprising a primary camera sensor 142a having an OIS sensor 224a, a secondary camera 142n having an OIS sensor 224n, and a transformation module 214 for calculating correction ratios 208a-n for the primary camera sensor 142a and secondary camera sensor 142n, in accordance with a first embodiment of the disclosure. In this embodiment, transformation module 214 receives, from camera sensor(s) 142a-n, movement data 204a-n associated with a detected movement of camera sensors 142a-n. In response to receiving movement data 204a-n, transformation module 214 calculates movement mean 302, which represents an average of the movement in each of X, Y, and Z directions of camera sensor 142a and camera sensor 142n during capture of media 202a-n, as shown in the formula below:

$${[ \begin{matrix}X \\ Y \\ Z \\ 1\end{matrix} ]}_{Movement Mean} = \frac{{[ \begin{matrix}X \\ Y \\ Z \\ 1\end{matrix} ]}_{PC Movement } + {[ \begin{matrix}X \\ Y \\ Z \\ 1\end{matrix} ]}_{SC Movement }}{n}$$

It should be noted that the n in the denominator of the equation above represents the number of camera sensors 142a-n for which transformation module 214 has received movement data 204a-n. Additionally, n represents the number of individual X-Y-Z data sets added together in the numerator of the above equation. It should be noted that the PC movement and the SC movement in the above equation represents movement data 204a and movement data 204n, respectively. Thus, in the illustrated example of FIG. 3 where transformation module 214 receives movement data 204a from primary camera sensor 142a and movement data 204n from secondary camera sensor 142n, n is 2.

In response to calculating movement mean 302, transformation module 214 calculates correction ratio 208a-n for each of camera 142a-n by multiplying movement mean 302 with calibration data 212a-n. More precisely, in calculating correction ratio (e.g., correction ratio 208a), transformation module 214 performs the below calculation:

$${[ \begin{matrix}X \\ Y \\ Z \\ 1\end{matrix} ]}_{Correction Ratio} = {[ [ \begin{matrix} & R & & T \\ 0 & 0 & 0 & 1\end{matrix} ] \times [ \begin{matrix}\frac{{L}_{x}}{\sqrt{{L}_{x}^{2} + {L}_{y}^{2}}} \\ \frac{{L}_{y}}{\sqrt{{L}_{x}^{2} + {L}_{y}^{2}}} \\ \frac{1}{\sqrt{{L}_{x}^{2} + {L}_{y}^{2}}} \\ 1\end{matrix} ] ]}_{Calibration} \times {[ \begin{matrix}X \\ Y \\ Z \\ 1\end{matrix} ]}_{Movement Mean }$$

As shown in the calculation above, calibration data 212a-n includes, for a particular camera (e.g., camera 142a), a rotation and translation matrix which is multiplied by a position matrix. In the rotation and translation matrix, R represents a rotation matrix and T represents a translation vector. In the position matrix, Lₓ represents a distance on an x-axis between primary camera sensor 142a secondary camera sensor 142n and L_{y} represents a distance on a y-axis between primary camera sensor 142a secondary camera sensor 142n.

In response to calculating correction ratios 208a-n for each of camera sensors 142a-n, transformation module 214 applies correction ratio 208a to primary camera sensor 142a and correction ratio 208n to secondary camera sensor 142n. By applying correction ratios 208a-n to camera sensors 142a-n, a position of lenses of camera sensors 142a-n is adjusted to compensate for a movement of primary camera sensor 142a and secondary camera sensor 142n. Primary camera sensor 142a and secondary camera sensor 142n thus capture media 202a and media 202n using the corrected lens positions provided by correction ratios 208a-n.

In response to completion of the capture of media 202a-n, CPU(s) 104 receives media 202a from primary camera sensor 142a and media 202n from secondary camera sensor 142n and fuses media 202a-n to generate a single optimized composite media (fused media 210). In response to generating fused media 210, CPU(s) 104 provides fused media 210 to at least one output device 222a-n. Fused media 210 may also be stored to memory 110 and/or another storage that is accessible to image capturing device 100.

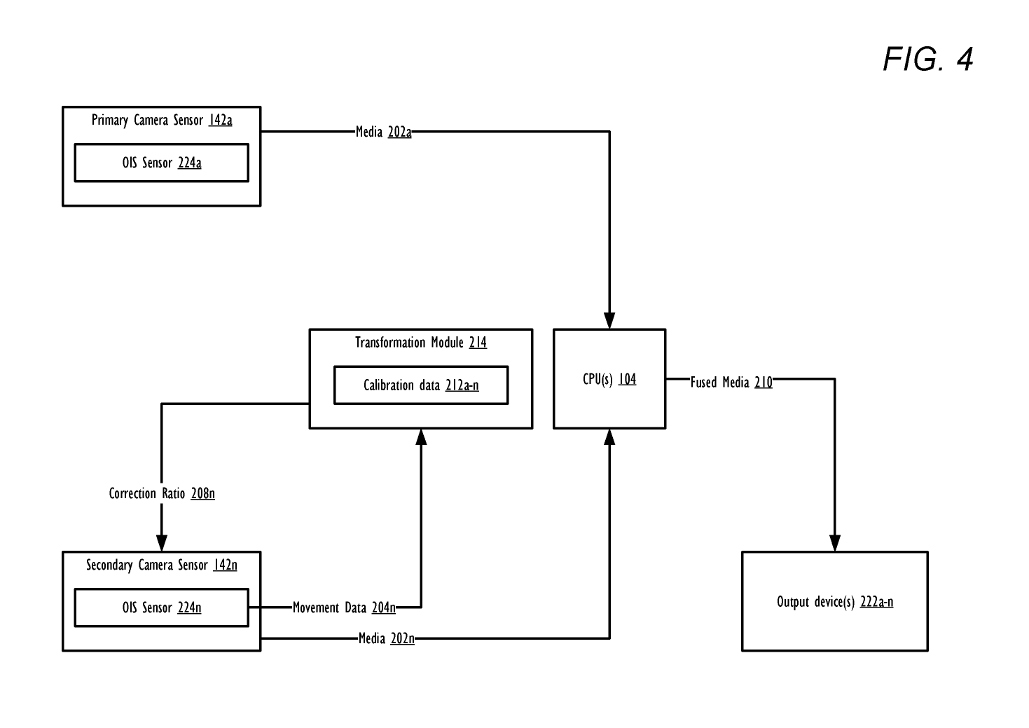

Referring now to FIG. 4, there is illustrated a second example image capturing device 100 comprising a primary camera 142a having an OIS sensor 224a, a secondary camera 142n having an OIS sensor 224n, and a transformation module 214 for calculating a correction ratio 208n for the secondary camera 142n, in accordance with a second embodiment of the disclosure. In this embodiment, transformation module 214 only receives movement data 204n from secondary camera sensor 142n, and primary camera 142a self-corrects for movement 204a via OIS sensor 224a (and does not provide movement data 204a to transformation module 214). In response to receiving movement data 204n, transformation module 214 calculates correction ratio 208n for only secondary camera sensor 142n by multiplying calibration data 212n with movement data 204n, as shown in the equation below:

$${[ \begin{matrix}X \\ Y \\ Z \\ 1\end{matrix} ]}_{SC Correction Ratio} = {[ [ \begin{matrix} & R & & T \\ 0 & 0 & 0 & 1\end{matrix} ] \times [ \begin{matrix}\frac{{L}_{x}}{\sqrt{{L}_{x}^{2} + {L}_{y}^{2}}} \\ \frac{{L}_{y}}{\sqrt{{L}_{x}^{2} + {L}_{y}^{2}}} \\ \frac{1}{\sqrt{{L}_{x}^{2} + {L}_{y}^{2}}} \\ 1\end{matrix} ] ]}_{SC Calibration} \times {[ \begin{matrix}X \\ Y \\ Z \\ 1\end{matrix} ]}_{SC Movement }$$

In response to calculating correction ratio 208n based on calibration data 212n and movement data 204n, transformation module 214 applies correction ratio 208n to only secondary camera sensor 142n. The application of correction ratio 208n to secondary camera sensor 142n corrects a position of a lens of camera sensors 142n and compensates for a movement of secondary camera sensor 142n. Thus, primary camera sensor 142a captures media 202a in conjunction with any self-correction applied by OIS sensor 224a while secondary camera sensor 142n captures media 202n using the corrected lens position provided by correction ratio 208n.

In response to completion of the capture of media 202a-n, CPU(s) 104 receives media 202a from primary camera sensor 142a and media 202n from secondary camera sensor 142n. CPU(s) 104 fuses media 202a-n to create fused media 210, which is provided to at least one output device 222a-n. Fused media 210 may also be stored to memory 110 and/or another storage that is accessible to image capturing device 100.

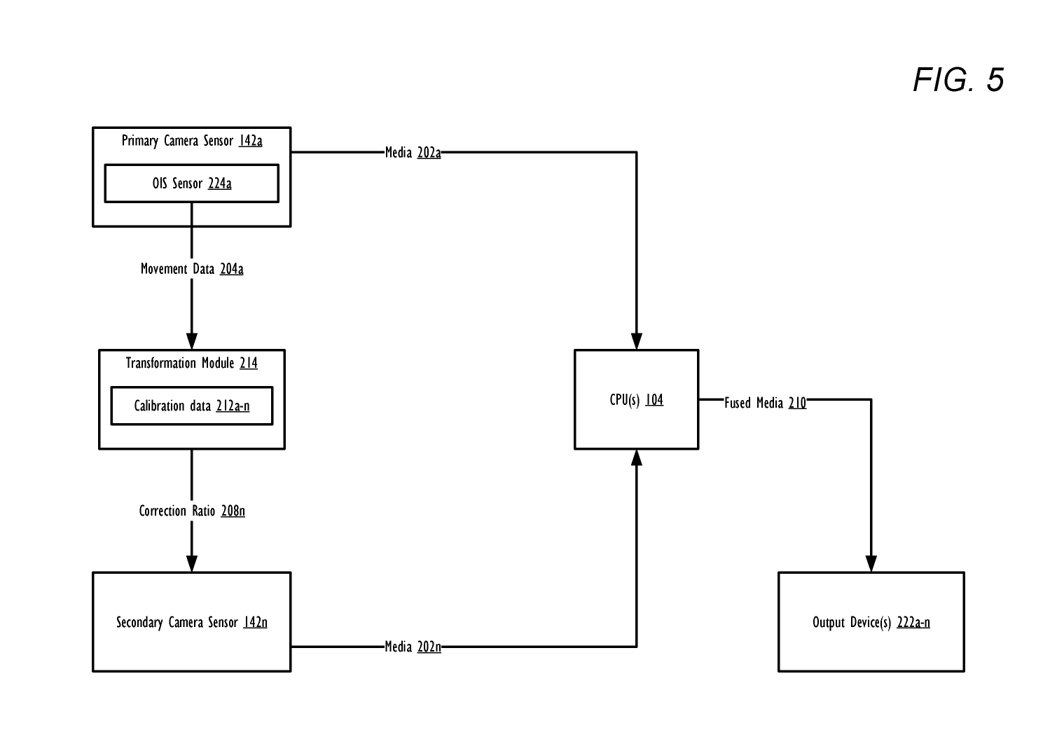

Referring now to FIG. 5, there is illustrated a third example image capturing device 100 comprising a primary camera sensor 142a having an OIS sensor 224a, a secondary camera 142n, and a transformation module 214 for calculating a correction ratio 208n for the secondary camera sensor 142n, in accordance with a third embodiment of the disclosure. In this embodiment, transformation module 214 only receives movement data 204a from primary camera sensor 142a. OIS sensor 224a self-corrects a position of a lens of primary camera 142a. Secondary camera sensor 142n does not include an OIS sensor and thus cannot detect secondary movement data 204n. During capture of media 202a, primary camera sensor 142a provides movement data 204a to transformation module 214. In response to receiving movement data 204a, transformation module 214 calculates correction ratio 208n for secondary camera sensor 142n by multiplying calibration data 212n with movement data 204a, as shown in the equation below:

$${[ \begin{matrix}X \\ Y \\ Z \\ 1\end{matrix} ]}_{SC Correction Ratio} = {[ [ \begin{matrix} & R & & T \\ 0 & 0 & 0 & 1\end{matrix} ] \times [ \begin{matrix}\frac{{L}_{x}}{\sqrt{{L}_{x}^{2} + {L}_{y}^{2}}} \\ \frac{{L}_{y}}{\sqrt{{L}_{x}^{2} + {L}_{y}^{2}}} \\ \frac{1}{\sqrt{{L}_{x}^{2} + {L}_{y}^{2}}} \\ 1\end{matrix} ] ]}_{SC Calibration} \times {[ \begin{matrix}X \\ Y \\ Z \\ 1\end{matrix} ]}_{PC Movement }$$

In response to calculating correction ratio 208n, transformation module 214 applies correction ratio 208n to only secondary camera sensor 142n to correct a position of a lens of camera sensors 142n based on a movement of primary camera sensor 142a identified within movement data 204a.

Primary camera sensor 142a captures media 202a in conjunction with any self-correction applied by OIS sensor 224a while secondary camera sensor 142n captures media 202n using the corrected lens position provided by correction ratio 208n. In response to completion of the capture of media 202a-n, CPU(s) 104 receives media 202a from primary camera sensor 142a and media 202n from secondary camera sensor 142n. CPU(s) 104 fuses media 202a-n to create fused media 210, which is provided to at least one output device 222a-n. Fused media 210 may also be stored to memory 110 and/or another storage that is accessible to image capturing device 100.

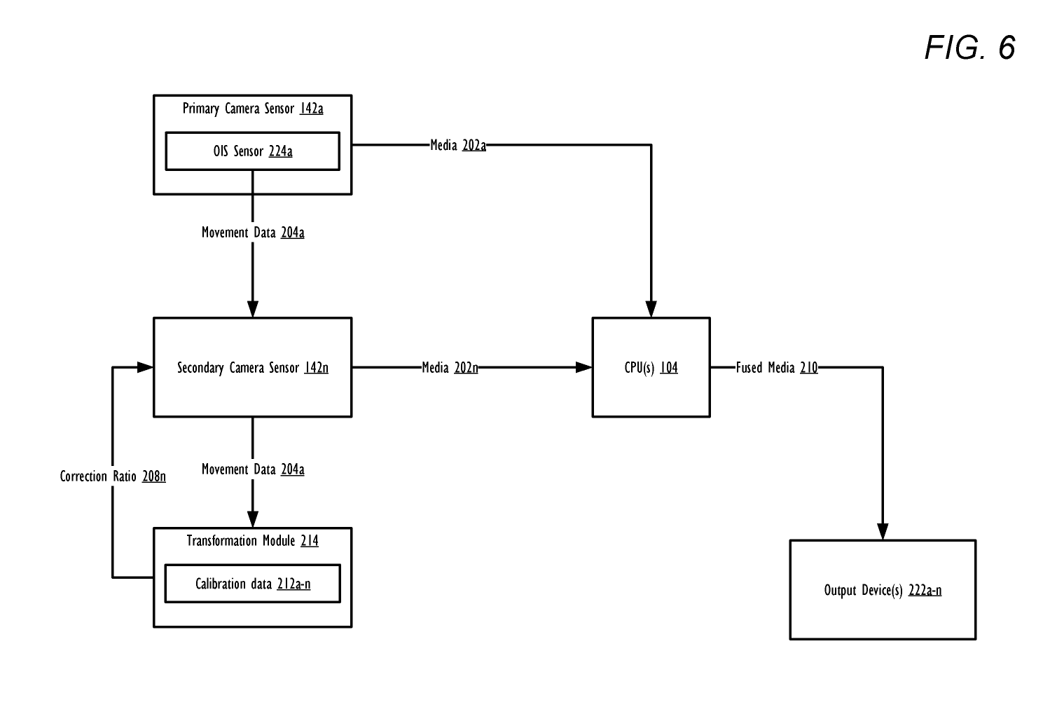

Referring now to FIG. 6, there is illustrated a fourth example image capturing device 100 comprising a primary camera sensor 142a having an OIS sensor 224a, a secondary camera sensor 142n that is directly connected to the primary camera 142a, and a transformation module 214 for calculating a correction ratio 208n for the secondary camera sensor 142n, in accordance with a fourth embodiment of the disclosure. In this example, transformation module 214 calculates correction ratio 208n to apply to a lens of at least one secondary camera sensor 142n based on a detected movement (e.g., movement data 204a) of primary camera sensor 142a.

OIS sensor 224a self-corrects a position of a lens of primary camera 142a. Secondary camera sensor 142n does not include an OIS sensor and thus cannot detect secondary movement data 204n. As illustrated, primary camera sensor 142a is directly connected to secondary camera sensor 142n. During capture of media 202a by primary camera 142a, Secondary camera sensor 142n receives primary movement data 204a from primary camera 142a in real time and automatically routes primary movement data 204a to transformation module 214.

In response to receiving movement data 204a from secondary camera 142n, transformation module 214 calculates correction ratio 208n for secondary camera sensor 142n by multiplying calibration data 212n with movement data 204a, as shown in the equation below:

$${[ \begin{matrix}X \\ Y \\ Z \\ 1\end{matrix} ]}_{SC Correction Ratio} = {[ [ \begin{matrix} & R & & T \\ 0 & 0 & 0 & 1\end{matrix} ] \times [ \begin{matrix}\frac{{L}_{x}}{\sqrt{{L}_{x}^{2} + {L}_{y}^{2}}} \\ \frac{{L}_{y}}{\sqrt{{L}_{x}^{2} + {L}_{y}^{2}}} \\ \frac{1}{\sqrt{{L}_{x}^{2} + {L}_{y}^{2}}} \\ 1\end{matrix} ] ]}_{SC Calibration} \times {[ \begin{matrix}X \\ Y \\ Z \\ 1\end{matrix} ]}_{PC Movement }$$

In response to calculating correction ratio 208n, transformation module 214 applies correction ratio 208n to only secondary camera sensor 142n to correct a position of a lens of camera sensors 142n based on a movement of primary camera sensor 142a identified within movement data 204a. Primary camera sensor 142a captures media 202a in conjunction with any self-correction applied by OIS sensor 224a while secondary camera sensor 142n captures media 202n using the corrected lens position provided by correction ratio 208n.

In response to completion of the capture of media 202a-n, CPU(s) 104 receives media 202a from primary camera sensor 142a and media 202n from secondary camera sensor 142n. CPU(s) 104 fuses media 202a-n to create fused media 210, which is provided to at least one output device 222a-n. Fused media 210 may also be stored to memory 110 and/or another storage that is accessible to image capturing device 100. It should also be noted that while transformation module 214 is depicted in FIG. 6 as a separate component from secondary camera sensor 142n, in another embodiment, transformation module 214 may be component of, or may be combined with, secondary camera sensor 142n.

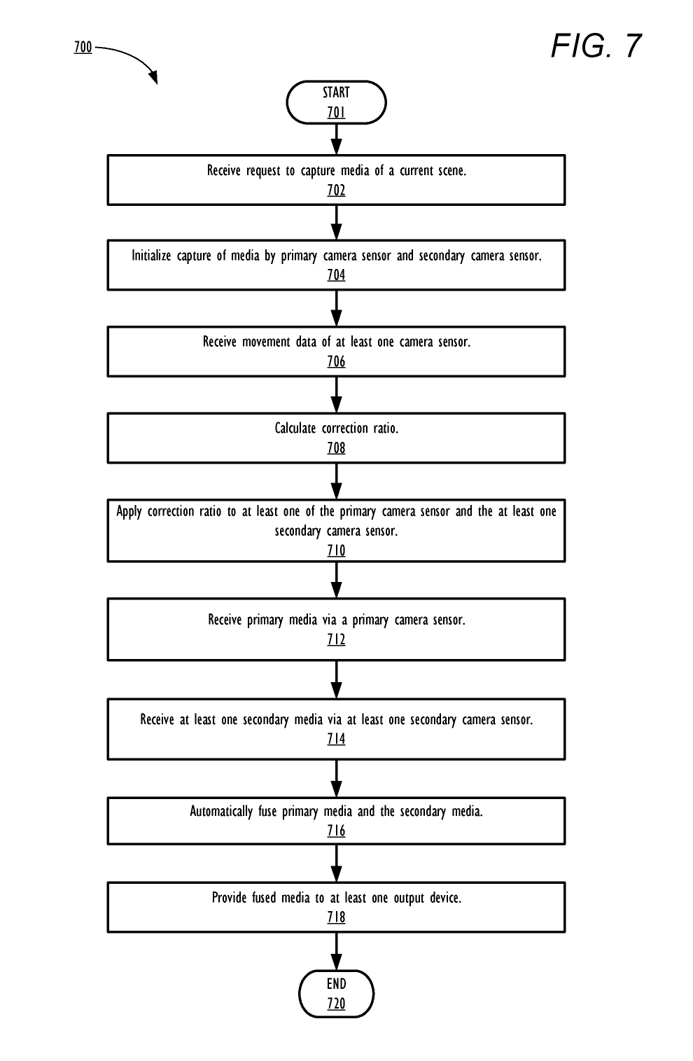

Referring now to FIG. 7, there is depicted a high-level flow-chart illustrating a method for correcting for a detected movement of at least one camera during capture of media and fusing media captured by a plurality of camera sensors to create a fused media, in accordance with one or more embodiments of the present disclosure. Aspects of the method are described with reference to the components of FIGS. 1-2. Several of the processes of the method provided in FIG. 7 can be implemented by a processor (e.g., CPU(s) 104) executing software code of TU 117 within an image capturing device (e.g., image capturing device 100). The method processes described in FIG. 7 are generally described as being performed by components of image capturing device 100.

Method 700 commences at initiator block 701 then proceeds to block 702. At block 702, CPU(s) 104 receives/detects request 218 to capture media of current scene 230. In response to receiving request 218, CPU(s) 104 initializes the capture of media 202a-n by camera sensors 142a-n (block 704). At block 706, a transformation module (e.g., transformation module 214) receives movement data (e.g., movement data 204a-n) from at least one of camera sensors 142a-n. At block 708, transformation module 214 calculates correction ratio(s) 208a-n based on received movement data 204a-n and calibration data 212a-n. At block 710, transformation module 214 provides/applies correction ratio(s) 208a-n to at least one of camera sensors 142a-n. At block 712, CPU(s) 104 receives primary media 202a from primary camera sensor 142a (block 712) and contemporaneously receives secondary media 202n from secondary camera sensor(s) 142n (block 714). At block 716, CPU(s) 104 automatically fuses media 202a-n to create fused media 210. At block 718, fused media 210 is provided to at least one output device (e.g., display 145). Method 700 then terminates at end block 720.

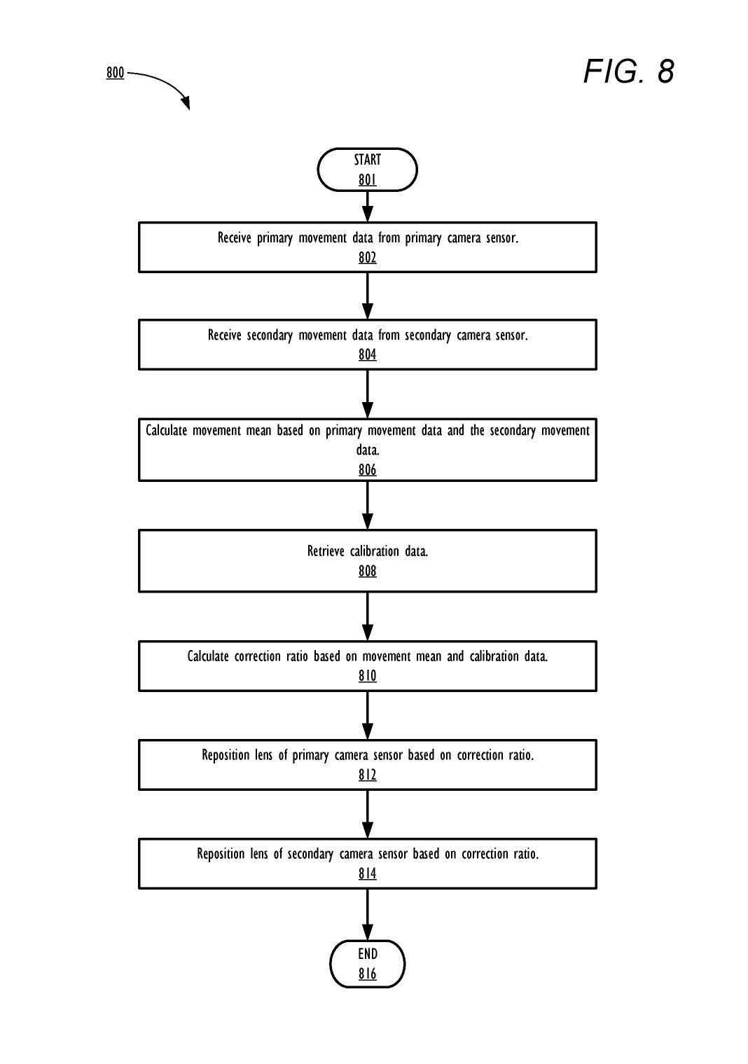

The methods presented in FIGS. 8-11 describe several different embodiments in which CPU(s) 104 calculates correction ratio(s) 208a-n for each of camera sensors 142a-n based on detected movement data 204a-n and fuses captured media 202a-n to create fused media 210. Aspects of the methods described in FIGS. 8-11 below are described with reference to the components of FIGS. 1-2. Several of the processes of the methods provided in FIGS. 8-11 can be implemented by a transformation module (e.g., transformation module 214). In one embodiment, the transformation module is a processor (e.g., CPU(s) 104) executing software code of TU 117 within an image capturing device (e.g., image capturing device 100). The methods described in FIGS. 8-11 are generally described as being performed by components of image capturing device 100.

Referring now to FIG. 8, there is depicted a high-level flow chart illustrating a method for determining a correction ratio to apply to a lens of a primary camera sensor and a lens of at least one secondary camera sensor based on a detected movement of the primary camera sensor and a detected movement of the at least one secondary camera sensor, in accordance with the first embodiment of the disclosure. In the method described by FIG. 8, primary camera 142a and secondary camera sensor(s) 142n are each equipped with an OIS sensor, as illustrated in FIG. 3. Method 800 commences at initiator block 801 then proceeds to block 802. At block 802, transformation module 214 receives primary movement data (e.g., primary movement data 204a) from primary camera 142a. At block 804, transformation module 214 receives at least one secondary movement data (e.g., secondary movement data 204n) from secondary camera sensor(s) 142n. At block 806, transformation module 214 calculates movement mean 302 of image capturing device 100 based on primary movement data 204a and secondary movement data 204n. At block 808, transformation module 214 retrieves calibration data 212a-n. At block 810, transformation module 214 calculates correction ratio 208a-n for camera sensors 142a-n based on movement mean 302 and calibration data 212a-n. In response to calculating correction ratios 208a-n, transformation module 214 repositions primary camera sensor 142a based on correction ratio 208a (block 812) and secondary camera sensor(s) 142n based on correction ratio 208n (block 814). Method 800 then terminates at end block 816.

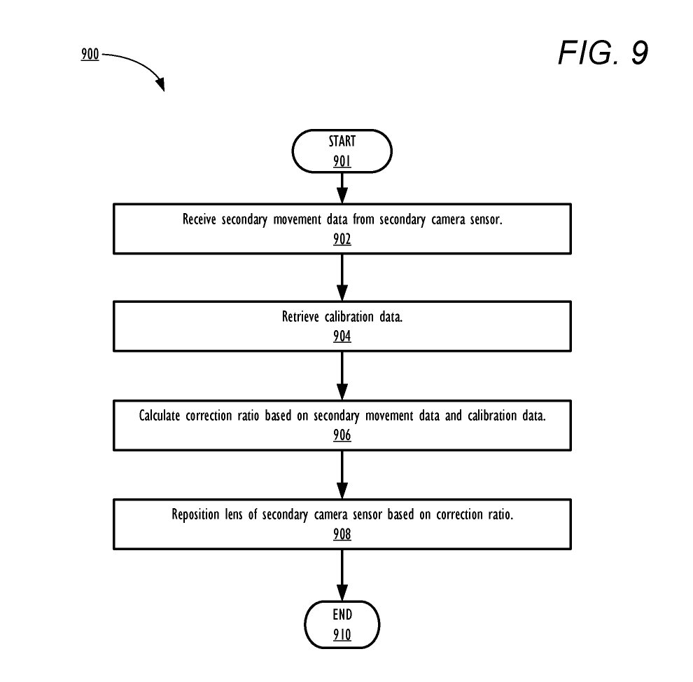

Referring now to FIG. 9, there is depicted a high-level flow chart illustrating a method for determining a correction ratio to apply to a lens of at least one secondary camera sensor based on a detected movement of the at least one secondary camera sensor, in accordance with the second embodiment of the disclosure. In the method described by FIG. 9, primary camera 142a and secondary camera sensor(s) 142n are each equipped with an OIS sensor, as illustrated in FIG. 4. Method 900 commences at initiator block 901 then proceeds to block 902. At block 902, transformation module 214 receives secondary movement data 204n from secondary camera sensor(s) 142n. At block 904, transformation module 214 retrieves calibration data 212n. At block 906, transformation module 214 calculates correction ratio 208n based on secondary movement data 204n and calibration data 212n. At block 908, transformation module 214 repositions the lens of secondary camera sensor(s) 142n based on correction ratio 208n. Method 900 then terminates at end block 910.

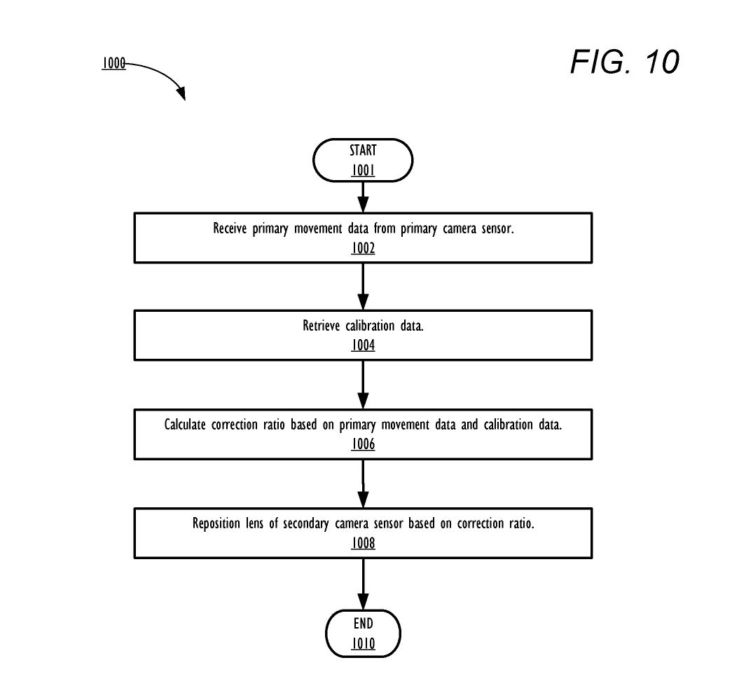

Referring now to FIG. 10, there is depicted a high-level flow chart illustrating a method for determining a correction ratio to apply to a lens of at least one secondary camera sensor based on a detected movement of the at least one primary camera sensor, in accordance with the third embodiment of the disclosure. In the method described by FIG. 10, only primary camera 142a is equipped with an OIS sensor, as illustrated in FIG. 5. Method 1000 commences at initiator block 1001 then proceeds to block 1002. At block 1002, transformation module 214 receives primary movement data 204a from primary camera sensor 142a. At block 1004, transformation module 214 retrieves calibration data 212n. At block 1006, transformation module 214 calculates correction ratio 208n based on primary movement data 204a and calibration data 212n. At block 1008, transformation module 214 repositions the lens of secondary camera sensor(s) 142n based on correction ratio 208n. Method 1000 then terminates at end block 1010.

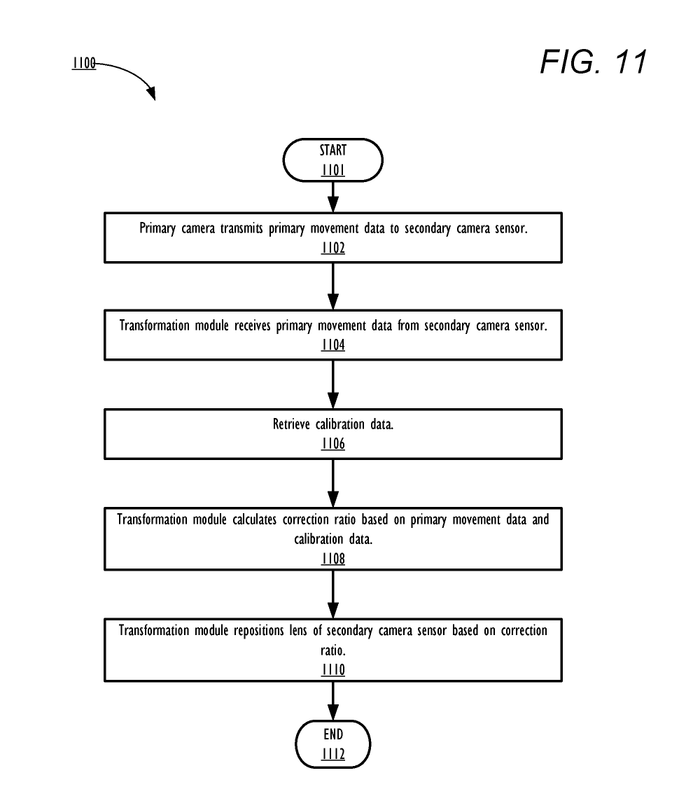

Referring now to FIG. 11, there is depicted a high-level flow chart illustrating a method for determining a correction ratio to apply to a lens of at least one secondary camera sensor based on a detected movement of the at least one primary camera sensor, in accordance with the fourth embodiment of the disclosure. In the method described by FIG. 11, only primary camera 142a is equipped with an OIS sensor and primary camera sensor 142a and secondary camera sensor 142n are directly connected, as illustrated in FIG. 6. Method 1100 commences at initiator block 1101 then proceeds to block 1102. At block 1102, secondary camera sensor(s) 142n receives primary movement data 204a via a direct connection to primary camera 142a. At block 1104, transformation module 214 receives primary movement data 204a from secondary camera sensor(s) 142n. At block 1106, transformation module 214 retrieves calibration data 212n. At block 1108, transformation module 214 calculates correction ratio 208n based on primary movement data 204a and calibration data 212n. At block 1110, transformation module 214 repositions the lens of secondary camera sensor(s) 142n based on correction ratio 208n. Method 1100 then terminates at end block 1112.

In the above-described flow charts, one or more of the method processes may be embodied in a computer readable device containing computer readable code such that a series of steps are performed when the computer readable code is executed on a computing device. In some implementations, certain steps of the methods are combined, performed simultaneously or in a different order, or perhaps omitted, without deviating from the scope of the disclosure. Thus, while the method steps are described and illustrated in a particular sequence, use of a specific sequence of steps is not meant to imply any limitations on the disclosure. Changes may be made with regards to the sequence of steps without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain, or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

1. A method comprising:
receiving, via at least one input device, a request to capture a media of a current scene;
capturing a primary media via a primary camera sensor that includes an optical image stabilization (OIS) sensor that autonomously moves a lens of the primary camera sensor to compensate for a primary movement of the primary camera sensor during capture of the current scene;
simultaneously capturing at least one secondary media via at least one secondary camera sensor, wherein each of the at least one secondary camera sensor comprises a lens;
during capture of the primary media and the at least one secondary media, repositioning at least one lens of at least one of the primary camera sensor and the at least one secondary camera sensor to compensate for a detected movement of at least one of the primary camera sensor and the at least one secondary camera sensor;
automatically fusing the primary media and the at least one secondary media to create a fused media; and
providing the fused media to at least one output device.

2. The method of claim 1, wherein:
each of the at least one secondary camera sensors includes an OIS sensor that autonomously moves a lens of a corresponding secondary camera sensor to compensate for a secondary movement of the secondary camera sensor during capture of the current scene; and
repositioning the at least one lens further comprises:
the primary camera sensor transmitting primary movement data corresponding to the primary movement to a transformation module in real time;
the at least one secondary camera sensor transmitting secondary movement data corresponding to the secondary movement to the transformation module in real time;
calculating, by the transformation module, a movement mean based on the primary movement data and the secondary movement data;
calculating, via the transformation module, a correction ratio in each of X, Y, and Z directions based on the movement mean and a calibration data that specifies a distance between the primary camera sensor and the at least one secondary camera sensor; and
repositioning the lens of the primary camera sensor and the lens of the at least one secondary camera sensor based on the correction ratio.

3. The method of claim 1, wherein each of the at least one secondary camera sensors includes an OIS sensor that autonomously moves a lens of a corresponding secondary camera sensor to compensate for a secondary movement of the secondary camera sensor during capture of the current scene, and wherein repositioning the at least one lens further comprises:
the at least one secondary camera sensor transmitting secondary movement data corresponding to the secondary movement to the transformation module in real time;
calculating, via the transformation module, a correction ratio in each of X, Y, and Z directions based on the secondary movement data and a calibration data that specifies a distance between the primary camera sensor and the at least one secondary camera sensor; and
repositioning the lens of the at least one secondary camera sensor based on the correction ratio.

4. The method of claim 1, wherein repositioning the at least one lens further comprises:
the primary camera sensor transmitting the primary movement data corresponding to the primary movement to a transformation module in real time;
calculating, via the transformation module, a correction ratio in each of X, Y, and Z directions based on the primary movement and a calibration data that specifies a distance between the primary camera sensor and the at least one secondary camera sensor; and
repositioning a lens of the at least one secondary camera sensor based on the correction ratio.

5. The method of claim 1, wherein repositioning the at least one lens further comprises:
the primary camera sensor transmitting, to the at least one secondary camera sensor, primary movement data corresponding to the primary movement in real time;
the at least one secondary camera sensor receiving the primary movement data;
the at least one secondary camera sensor transmitting the primary movement data to a transformation module;
calculating, via the transformation module, a correction ratio in each of X, Y, and Z directions based on the primary movement data and a calibration data that specifies a distance between the primary camera sensor and the at least one secondary camera sensor; and
repositioning a lens of the at least one secondary camera sensor based on the correction ratio.

6. The method of claim 1, wherein the primary camera sensor and the at least one secondary camera sensor includes at least one of color camera sensors and monochromatic camera sensors.

7. The method of claim 1, wherein a media comprises at least one of a still image, a burst image, and a video.

8. An image capturing device comprising:
at least one input device that receives a request to capture a media of a current scene;
a primary camera sensor that captures a primary media of the current scene, wherein primary camera sensor includes a primary optical image stabilization (OIS) sensor that autonomously moves a lens of the primary camera sensor during capture of the current scene;
at least one secondary camera sensor that simultaneously captures at least one secondary media of the current scene, wherein each of the at least one secondary camera sensor comprises a lens;
a transformation module that repositions at least one lens of at least one of the primary camera sensor and the at least one secondary camera sensor during capture of the primary media and the at least one secondary media to compensate for a detected movement of at least one of the primary camera sensor and the at least one secondary camera sensor; and
at least one processor that:
automatically fuses the primary media and the at least one secondary media to create a fused media; and
provides the fused media to at least one output device.

9. The image capturing device of claim 8, wherein:
each of the at least one secondary camera sensors includes an OIS sensor that autonomously moves a lens of a corresponding secondary camera sensor to compensate for a secondary movement of the secondary camera sensor during capture of the current scene; and
in repositioning the at least one lens, the transformation module:
receives, in real time, primary movement data corresponding to the primary movement via the primary camera sensor and secondary movement data corresponding to the secondary movement via the at least one secondary camera sensor;
calculates a movement mean based on the primary movement data and the secondary movement data;
calculates a correction ratio in each of X, Y, and Z directions based on the movement mean and a calibration data that specifies a distance between the primary camera sensor and the at least one secondary camera sensor; and
repositions the lens of the primary camera sensor and the lens of the at least one secondary camera sensor based on the correction ratio.

10. The image capturing device of claim 8, wherein:
each of the at least one secondary camera sensors includes an OIS sensor that autonomously moves a lens of a corresponding secondary camera sensor to compensate for a secondary movement of the secondary camera sensor during capture of the current scene; and
in repositioning the at least one lens, the transformation module:
receives, in real time, secondary movement data corresponding to the secondary movement via the at least one secondary camera sensor;
in response to receiving the secondary movement data, calculates a correction ratio in each of X, Y, and Z directions based on the secondary movement data and a calibration data that specifies a distance between the primary camera sensor and the at least one secondary camera sensor; and
repositions the lens of the at least one secondary camera sensor based on the correction ratio.

11. The image capturing device of claim 8, wherein:
in repositioning the at least one lens, the transformation module:
receives, in real time, primary movement data corresponding to the primary movement via the primary camera sensor;
calculates a correction ratio in each of X, Y, and Z directions based on the primary movement data and a calibration data that specifies a distance between the primary camera sensor and the at least one secondary camera sensor; and
repositions a lens of the at least one secondary camera sensor based on the correction ratio.

12. The image capturing device of claim 8, wherein:
the primary camera sensor transmits primary movement data corresponding to the primary movement to the at least one secondary camera sensor in real time; and
in repositioning the at least one lens, the transformation module:
receives, in real time, the primary movement data via the secondary camera sensor;
calculates a correction ratio in each of X, Y, and Z directions based on the primary movement data and a calibration data that specifies a distance between the primary camera sensor and the at least one secondary camera sensor; and
repositions a lens of the at least one secondary camera sensor based on the correction ratio.

13. The image capturing device of claim 8, wherein the primary camera sensor and the at least one secondary camera sensor includes at least one of color camera sensors and monochromatic camera sensors.

14. The image capturing device of claim 8, wherein a media comprises at least one of a still image, a burst image, and a video.

15. A computer program product comprising:
a non-transitory computer readable storage device; and
program code on the non-transitory computer readable storage device that when executed by a processor associated with an image capturing device, the program code enables the image capturing device to provide the functionality of:
receiving, via at least one input device, a request to capture a media of a current scene;
capturing a primary media via primary camera sensor that includes an optical image stabilization (OIS) sensor that autonomously moves a lens of the primary camera sensor to compensate for a primary movement of the primary camera sensor during capture of the current scene;
simultaneously capturing at least one secondary media via at least one secondary camera sensor, wherein each of the at least one secondary camera sensor comprises a lens;
during capture of the primary media and the at least one secondary media, repositioning at least one lens of at least one of the primary camera sensor and the at least one secondary camera sensor to compensate for a detected movement of at least one of the primary camera sensor and the at least one secondary camera sensor;
automatically fusing the primary media and the at least one secondary media to create a fused media; and
providing the fused media to at least one output device.

16. The computer program product of claim 15, wherein:
each of the at least one secondary camera sensors includes an OIS sensor that autonomously moves a lens of a corresponding secondary camera sensor to compensate for a secondary movement of the secondary camera sensor during capture of the current scene; and
the program code for repositioning the at least one lens further comprises code for:
receiving, at a transformation module, primary movement data corresponding to the primary movement in real time;
receiving, at a transformation module, secondary movement data corresponding to the secondary movement in real time;
calculating a movement mean based on the primary movement data and the secondary movement data;
calculating a correction ratio in each of X, Y, and Z directions based on the movement mean and a calibration data that specifies a distance between the primary camera sensor the at least one secondary camera sensor; and
repositioning the lens of the primary camera sensor and the lens of the at least one secondary camera sensor based on the correction ratio.

17. The computer program product of claim 15, wherein:
each of the at least one secondary camera sensors includes an OIS sensor that autonomously moves a lens of a corresponding secondary camera sensor to compensate for a secondary movement of the secondary camera sensor during capture of the current scene; and
the program code for repositioning the at least one lens further comprises code for:
receiving, at a transformation module, secondary movement data corresponding to the secondary movement in real time;
calculating a correction ratio in each of X, Y, and Z directions based on the secondary movement data and a calibration data that specifies a distance between the primary camera sensor and the at least one secondary camera sensor; and
repositioning the lens of the at least one secondary camera sensor based on the correction ratio.

18. The computer program product of claim 15, the program code for further comprising code for:
receiving, at a transformation module, primary movement data corresponding to the primary movement in real time;
calculating a correction ratio in each of X, Y, and Z directions based on the primary movement data and a calibration data that specifies a distance between the primary camera sensor and the at least one secondary camera sensor; and
repositioning a lens of the at least one secondary camera sensor based on the correction ratio.
